(19) United States
(12) Patent Application Publication
(10) Pub. No.: US 2014/0337694 A1
(43) Pub. Date: Nov. 13, 2014

(54) METHOD FOR AUTOMATICALLY OPTIMIZING THE EFFECTIVENESS OF A WEBSITE

(71) Applicant: Lior Haramaty, Bergenfield, NJ (US)

(72) Inventor: Lior Haramaty, Bergenfield, NJ (US)

(21) Appl. No.: 14/274,151

(22) Filed: May 9, 2014

Related U.S. Application Data
(60) Provisional application No. 61/822,567, filed on May 13, 2013.

(51) Int. Cl. G06F 17/21; G06F 17/22

(52) U.S. Cl. CPC G06F 17/211; G06F 17/2247
USPC 715/204; 715/234

(57) ABSTRACT

A method of an evolutionary nature to automate the process of optimizing website elements, such as web page designs and/or colors and/or content and/or functionality, in order to optimize desired effectiveness and performance by dynamically monitoring performance and adjusting web page and/or website elements accordingly or randomly or as a combination of the two, while optionally dynamically changing test parameters. The process can result in either static or dynamic web design, and can be either stopped or started or become static at any time so that a continual and dynamic process is achieved.

### CROSS-REFERENCE TO RELATED APPLICATION

This application is based upon U.S. Provisional Application No. 61/822,567 filed on May 13, 2013, the entire disclosure of which is hereby incorporated by reference thereto.

### BACKGROUND OF THE INVENTION

1. Field of the Invention

The invention relates to website design effectiveness and optimization for electronic commerce, media websites and other usages.

2. Description of the Related Art

Analyzing a website is done all the time, although not necessarily in real time and not integrally. Such analyzing includes testing to improve the website and is commonly known as A/B or multivariate testing. Separately, dynamic websites, as they are called, as opposed to static websites, are common. Many websites have some dynamic elements that are changed “on the fly”. In other words, in the prior art, websites are being tested with two or more preselected options to determine possible changes. Then, a report is produced to show which options are better. Subsequently, the website owner makes a judgment call and decides whether he or she wants to make any recommended changes, according to information provided in the report. However, analyzing a website via multivariate testing and changing a website element “on the fly” via a dynamic process are not done at the same time and in combination with each other, automatically and continuously with a feedback loop or loops that change both the website and the testing parameters as a part of the process.

### BRIEF SUMMARY OF THE INVENTION

As far as is known, no one is testing effectiveness and changing elements of the website according to test results in an automatic way that feeds back each process based on the changing information to make the website better and better. Thus, the inventive method encompasses a combination of at least two processes, i.e., measuring the effectiveness of various elements and changing these elements on the website accordingly to find the best scenario for a specific reaction from users. To put it more simply, through a process of “evolution”, the best performing parameters for each website element win. The website owner does not just guess at which options may be best and then test them, as is now done in the prior art. Instead, with this invention, an algorithm finds the best option or options for changing various elements on the website, then changes those elements by zooming into the actual website which is modified to use the best performing parameter or parameters through a process by which the best performers survive.

Websites can have infinite possibilities for design and functionality. The result of changing a website design element such as color, font, location, order of questions, or link type can change a user's reaction in ways that are not always predictable, and can change over time, location, season and other parameters. The invention covers methods to optimize such elements in an automated way, measuring effectiveness and performance while changing and tweaking elements to improve desired performances and/or overall effectiveness of the website.

Effectiveness and performance can be defined as desired, can have multiple performance criteria and weight, and can change over time. For instance, they can be defined to optimize the performances, such as the number of orders submitted, the time a user spends on a website or a specific web page, the number of users reaching the site, the number of page views per user, the average revenue per order, etc.

The uniqueness of the invention lies in an automatic process that can change and monitor a website and web page elements to achieve the best results in the desired criteria or plurality of criteria, a process that can be either stopped at any time, or continued indefinitely, and that can change elements based on either statistical information or randomly, according to any other information, such as date, time, location, or a combination of some or all such factors.

### BRIEF DESCRIPTION OF THE DRAWINGS

The accompanying drawings are herein described by way of example only. It is stressed that the particulars shown are presented for the purpose of illustrative discussion of the embodiments of the invention. In this regard, the description provided with the drawings makes apparent to those skilled in the art how such embodiments of the invention may be practiced.

FIG. 1 is a flow chart describing, as an example, color manipulation of a web element with a goal of maximizing certain user reaction, based on feedback and statistical analysis, according to a first embodiment of the present invention.

FIG. 2 is a flow chart describing, as an example, web page background color manipulation with a goal of maximizing certain user reaction, based on feedback, statistical analysis and random choosing, according to a second embodiment of the present invention.

FIG. 3 is a flow chart describing, as an example, web page font size manipulation with a goal of maximizing the time a user spends on the website, based on statistical analysis of external analytics information about the site and random choosing, according to a third embodiment of the present invention.

FIG. 4 is a flow chart describing, as an example, web page background color and image manipulation with a goal of maximizing the number of users who click on the “contact us” link on the website, based on statistical analysis and random choosing, according to a fourth embodiment of the present invention.

FIG. 5 is a flow chart describing, as an example, web page background color manipulations with a goal of maximizing the number of users who click on the “store page” link on the website, based on statistical analysis that includes at least the user's location and the date, according to a fifth embodiment of the present invention.

### DETAILED DESCRIPTION OF THE PREFERRED EMBODIMENTS

The following detailed description of the drawings describes instances, as examples, of how the present invention may be used. The description incorporates reference to enumerated steps in each drawing for clarification where possible.

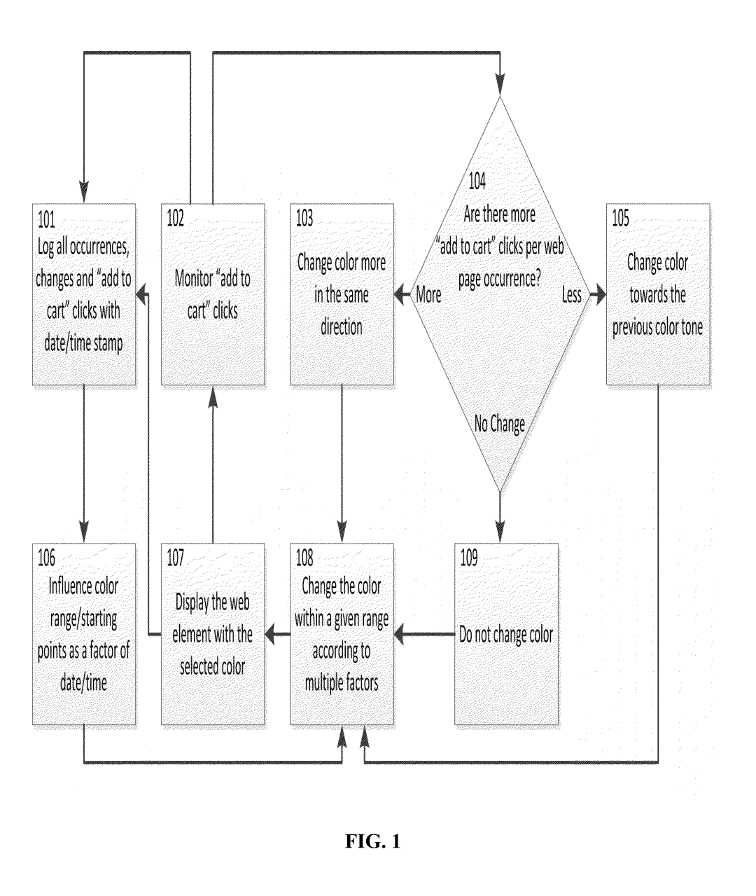

In FIG. 1, the flow chart shows an example of an instance where a color of a web element is changed in an attempt to maximize the number of “add to cart” clicks on a website. A range of the colors is predefined and an algorithm is allowed to change the color of the web element within that range.

In step 101, all occurrences, color changes, and “add to cart” clicks are logged with a date/time stamp. In step 102, the “add to cart” clicks are monitored. In step 104, an algorithm checks for the number of “add to cart” clicks. Specifically, the algorithm asks: “Are there more ‘add to cart’ clicks per web page occurrence?” If the answer is “yes, there are more clicks”, then the method proceeds to step 103 by which the color is changed more in the same direction. If the answer is “no, there are less clicks”, then the method proceeds to step 105 by which the color is changed towards the previous color tone. If the answer is that “there is no change”, then the method proceeds to step 109 by which the color is not changed.

Whether the color is changed more in the same direction in step 103 or is changed towards the previous color tone in step 105 or is not changed at all in step 109, the method then proceeds to step 108 by which the color is or is not changed within a given range, according to multiple factors. One of the multiple factors is determined in step 106 which influences the color range and starting points as a factor of date and time. These factors determined in step 106 are then fed into step 108. As a result, in step 107, the web element is displayed with the selected color. After step 107 is completed, the method returns to steps 101 and 102.

In this first embodiment, the algorithm can be asynchronous or synchronous. The process can continue indefinitely or can be stopped at any point to maintain the best color found currently for the web element. The process may be restarted at any time with the same or with different parameters.

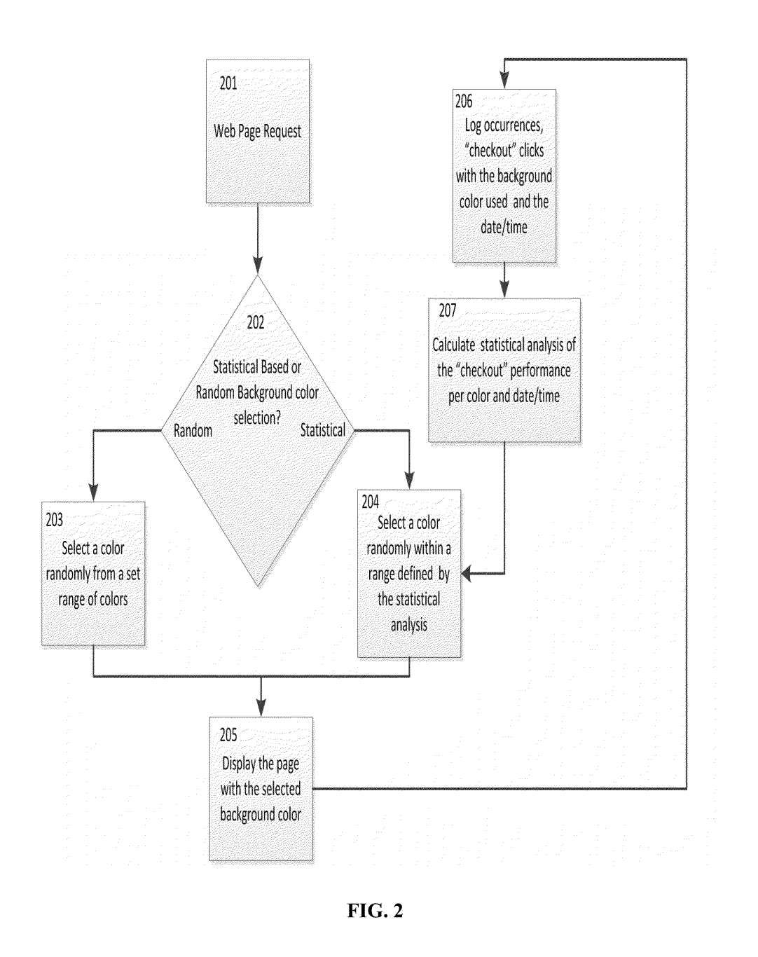

In FIG. 2, the flow chart shows an example of an instance where a web page background color is changed in an attempt to maximize the number of “checkout” clicks on the web site. The color range is predefined and the algorithm is allowed to change the background color of the web page within that range.

When a web page is requested in step 201, the background color that will be used when displaying the web page is then selected in step 202 to be either completely random in step 203 within a set range of colors or statistically based in step 204 within an optimized range defined by a statistical analysis of any previous data collected. Then, the web page is displayed with the selected background color in step 205. In step 206, all log occurrences, “checkout” clicks with the background color used, and the date/time, are monitored and logged.

In step 207, the algorithm calculates a statistical analysis of the “checkout” performance per background color and the date/time. The results of the statistical analysis are then fed into step 204 to select a color randomly within the range defined by the statistical analysis.

In this second embodiment, the algorithm can be asynchronous or synchronous. The process can continue indefinitely or can be stopped at any point to maintain the best background color found currently for the web element. The process may be restarted at any time with the same or with different parameters.

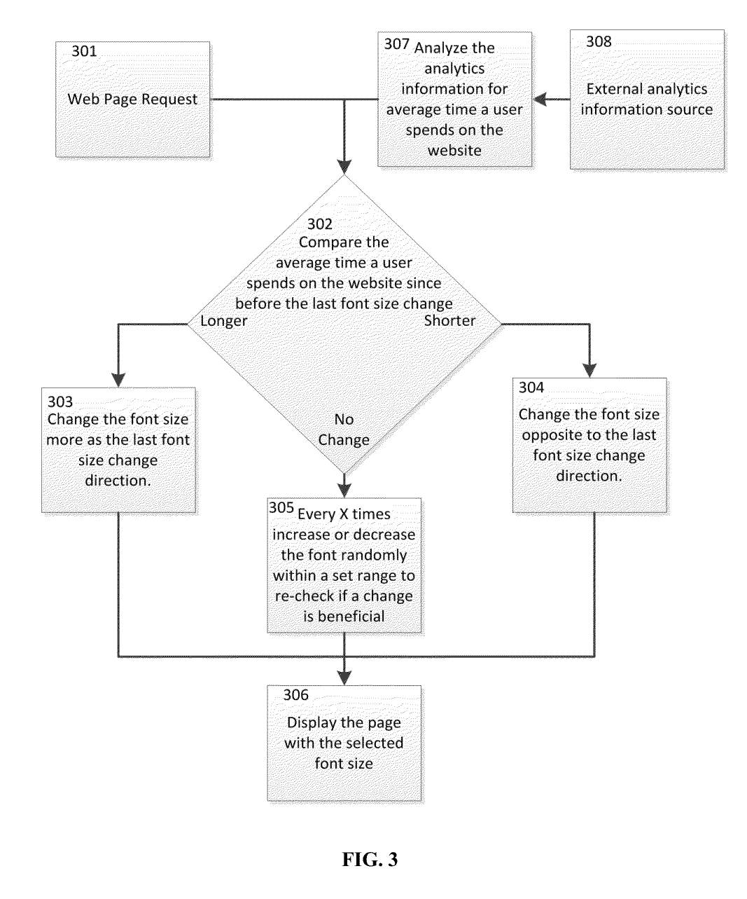

In FIG. 3, the flow chart shows an example of an instance where a font size used on a web page or on some or all pages of an entire website is changed in an attempt to maximize the amount of time users spend on the web site. A range of the font size is predefined and the algorithm is allowed to change the font size of the page or pages within that range.

In step 301, a web page request is received. In step 302, the algorithm compares the average time a user spent on the website since the time before the last font size change. If the time was longer, the algorithm changes the font size to be displayed next to make the font bigger or smaller in the same direction of size change that was done last in step 303. If the time was shorter, the algorithm changes the font size to be displayed next to make the font bigger or smaller opposite to the direction of size change that was done last in step 304. If there was no change in the average time that the user spent on the website since the time before the last font size change, then in step 305, after every X number of times, where X is a number selected by an operator, the algorithm either increases or decreases the font randomly within a set range to re-check if a change is beneficial. Then, whether the font was made bigger in step 303 or smaller in step 304 or not changed at all or changed randomly in step 305, the web page is displayed with the selected font size in step 306.

In step 308, the amount of time users spend on the website is obtained and measured by an external analytics information website, which is different than the website being manipulated. Then, in step 307, the algorithm analyzes the analytics information for the average time a user spends on the website in order to influence the font size in correlation with the analyzed information. The results of the analysis are then inputted into step 302.

In this third embodiment, the algorithm can be asynchronous or synchronous. The process can continue indefinitely or can be stopped at any point to maintain the best font size found currently to be most effective for the time spent on the website. The process may be restarted at any time with the same or with different parameters.

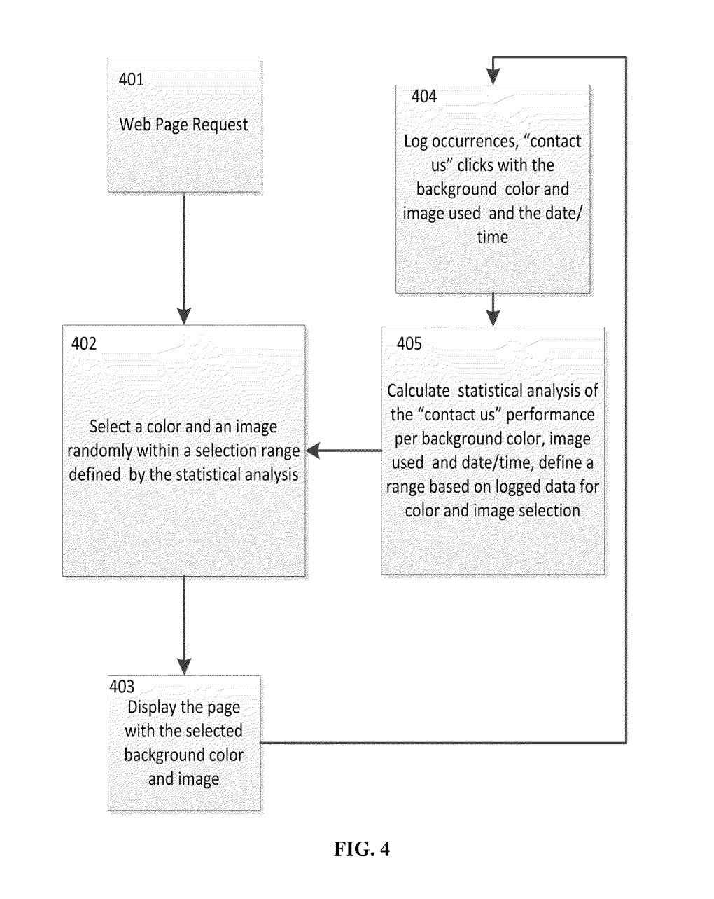

In FIG. 4, the flow chart shows an example of an instance where a web page background color and a displayed image are both changed in an attempt to maximize the number of users who click on the “contact us” link on the website. The background color range and the image selection options are both predefined and the statistical analysis narrows or expands the color range according to the logged website usage data.

When a display web page is requested in step 401, the method proceeds to step 402 by which the algorithm selects a background color and an image randomly within a selection range defined by the statistical analysis. Then, in step 403, the web page is displayed with the selected background color and image. In step 404, the number of log occurrences and the number of users clicking on “contact us” with the background color selected and the image used are logged along with the date/time of each occurrence and each click. In step 405, the data is analyzed by calculating a statistical analysis of the “contact us” performance per background color selected, image used, and date/time to define a range based on logged data for background color selection and image usage. The results are then fed back into step 402 in order to influence the range of background color selection and image usage.

In this fourth embodiment, the algorithm can be asynchronous or synchronous. The process can continue indefinitely or can be stopped at any point to maintain the best background color and image found currently to be most effective for the number of users who click on the “contact us” link on the website. The process may be restarted at any time with the same or with different parameters.

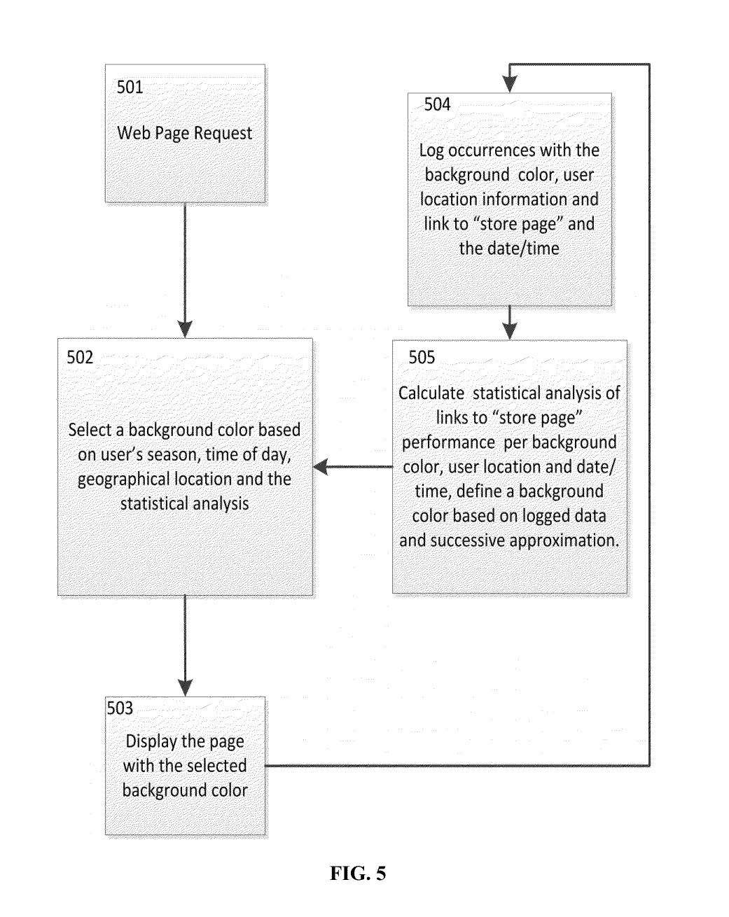

In FIG. 5, the flow chart shows an example of an instance where a web page background color is changed in an attempt to maximize the number of users who click on the “store page” link on the website. The background color range is predefined and the statistical analysis narrows or expands that range according to the logged website usage data.

When a web page is requested in step 501, the method proceeds to step 502 by which the algorithm randomly selects a background color, based on the user's season, time of day, geographical location, and the statistical analysis to date. Then, in step 503, the web page is displayed with the selected background color. The number of users clicking on a link to “store page” is logged in step 504. Specifically, the number of log occurrences with the selected background color, the users' geographical location information, and the link to “store page”, along with the date/time, are logged. In step 505, the data is analyzed in order to influence the range of background color selection. Specifically, the method calculates a statistical analysis of the links to “store page” performance per selected background color, user location, and date/time to define a background color based on logged data and successive approximation. The results of the statistical analysis are then fed by a processor back to step 502.

The algorithm can be asynchronous or synchronous. The process can continue indefinitely or can be stopped at any point to maintain the best background color found currently to be most effective for the number of users who click on the “store page” link on the website. The process may be restarted at any time with the same or with different parameters.

In summary, the method of the present invention automatically optimizes the effectiveness of a website activity or a plurality of website activities by monitoring various parameters while changing a design element or a plurality of the design elements on the website, according to the parameters. Instead of a design element or a plurality of the design elements, the method of the present invention may change one or more of the following: a content element or a plurality of the content elements; one or more images and/or videos; one or more hyperlinks; one or more audio content elements; any media file or a plurality of media files; one or more elements that influence accessibility and/or performance of the website such as, but not limited to, speed, resolution, color depth, and the like; any element or a plurality of elements that can be perceived consciously or subconsciously by a user of the website; one or more offerings on the website such as, but not limited to, prices, shipping options, sales, deals, product packaging, product names, monetary incentives, referral incentives, and the like; and any functionality of the website.

Furthermore, the method may be carried out while dynamically measuring and optimizing the effectiveness of a website activity, as related to a time of day, a date, geographical locations of the users, a best approximation of the geographical locations of the users, a season of the year either at a user's location or elsewhere, a language setting of a machine accessing the website, any information that is known about a machine and/or a user accessing the website, any information that is either assumed or pre-evaluated or pre-acquired about a user accessing the website, and any information either dynamic or predefined.

Also, the method may be carried out while receiving performance data from either the same website that is being optimized or an external source or both the same website and an external source.

Additionally, the method may be carried out while analyzing and/or changing multiple websites.

Thus, in effect, the invention may be broadly defined as a method comprising the steps of monitoring various parameters on a website on which an activity or a plurality of activities is carried out; changing an element or a plurality of elements on the website according to changes in monitored parameters; and optimizing automatically an effectiveness of the activity or the plurality of activities as a result of a changed element or a plurality of changed elements.

The first embodiment of the invention may be defined as a method comprising the steps of logging all occurrences, changes, and add-to-cart clicks on a website with date/time stamps; influencing a color range and color starting points as a factor of the date/time stamps; monitoring the add-to-cart clicks; querying whether there are more or less add-to-cart clicks per web page occurrence; if an answer is that there are more add-to-cart clicks per web page occurrence, then changing a color more in a same direction; if the answer is that there are less add-to-cart clicks per web page occurrence, then changing the color towards a previous color tone; if the answer is that there is no change in add-to-cart clicks per web page occurrence, then not changing the color; and displaying a web element with a selected color.

The second embodiment of the invention may be defined as a method comprising the steps of receiving a web page request; querying whether a background color selection should be either statistically based or randomly based; if statistically based, selecting a background color within a range defined by a statistical analysis; if randomly based, selecting the background color randomly from a set range of colors; displaying the web page with a selected background color; logging all occurrences and checkout clicks with background colors used and date/time of each of the checkout clicks; calculating the statistical analysis of checkout performance per background color and the date/time of each of the checkout clicks; and feeding the statistical analysis back to the step of selecting the background color within the range defined by the statistical analysis.

The third embodiment of the invention may be defined as a method comprising the steps of receiving a web page request; comparing an average time a user now spends on a website with the average time the user spent on the website before a last font size change; if the average time the user now spends is longer, making a font size change more as the last font size change; if the average time the user now spends is shorter, making the font size change opposite to the last font size change; if the average time the user now spends is not changed, then, after every X number of times, where X is a number selected by an operator, increasing or decreasing the font size randomly within a set range to re-check if the font size change is beneficial; displaying the web page with a selected font size change; obtaining analytics information from an external source; analyzing the analytics information for the average time the user spends on the website; and feeding the average time the user spends on the website back to the comparing step.

The fourth embodiment of the invention may be defined as a method comprising the steps of receiving a web page request; selecting a background color and an image randomly for the web page within a selection range defined by a statistical analysis; displaying the web page with a selected background color and image; logging occurrences and contact-us clicks with the selected background color and image and a date/time for each of the contact-us clicks; calculating the statistical analysis of the contact-us clicks per the selected background color, the image and the date/time; defining the selection range based on logged data for the selected background color and image; and feeding the selection range to the selecting step.

The fifth embodiment of the invention may be defined as a method comprising the steps of receiving a web page request; selecting a background color based on a user's season, time of day, a user's geographical location, and a statistical analysis; displaying the web page with a selected background color; logging occurrences with the selected background color, the user's geographical location, a link to store page, and a date/time; calculating the statistical analysis of links to store page per the selected background color, the user's geographical location, and the date/time; defining the background color based on logged data and successive approximation; and feeding the statistical analysis back to the selecting step.

An original version of the website or an element thereof may be kept as a reference and exposed to a portion of users, e.g. 5%, accessing the website to provide a reference benchmark for improvement. In other words, the original version can be a reference to a modified website that is under the process of optimization. The sampled portion of users may be called a control portion or a control group, as in a scientific or clinical study.

Finally, the method may be carried out with a processor or a plurality of processors that either run for a period of time then stop, or run continuously, or run continuously and dynamically change either the website or a plurality of websites.

While the drawings and descriptions describe different embodiments of the invention, the present invention allows expansions, adaptations, additions, substitutions, other implementations and other modifications to the demonstrated methods. Accordingly, the drawings and detailed descriptions do not limit the invention in any way. Instead, the scope of the invention is defined by the appended claims.

What I claim as my invention is:

1. A method comprising:
monitoring various parameters on a website or part of a website on which an activity, an activity level, or a plurality of activities is carried out;
changing an element or a plurality of elements on the website or on part of the website according to changes in monitored parameters; and
optimizing automatically an effectiveness of the website or part of the website to achieve a desired activity, a desired activity level or a desired plurality of activities as a result of a changed element or a plurality of changed elements.

2. The method according to claim 1, wherein the element or the plurality of elements includes one or more of a design; a content; an image; a video; a hyperlink; an audio; a media file; any element that influences accessibility and/or performance of the website such as, but not limited to, speed, resolution, and color depth; an element that can be perceived by a user consciously or subconsciously; any offering on the website such as, but not limited to, a price, a shipping option, a sale, a deal, a product packaging, a name, a monetary incentive, and a referral incentive; and any functionality of the website.

3. The method according to claim 1, further comprising:
dynamically measuring the effectiveness of the website or the part of the website to achieve the desired activity, the desired activity level, or the desired plurality of activities.

4. The method according to claim 1, wherein an original version of the website or the element is kept and exposed to a portion of users to provide a reference benchmark for improvement.

5. The method according to claim 3, wherein a dynamically measured feature of the activity or the plurality of activities relates to one of a date, a time of day, a geographical location of a user, a best approximation of the user's geographical location, a season of year either at the user's geographical location or at another location, a language setting of a machine accessing the website, any information that is known about the machine and/or a user accessing the website, any information that is assumed about the user accessing the website, any information that was pre-evaluated about the user accessing the website, any information that was pre-acquired about the user accessing the website, and any information either dynamic or predefined.

6. The method according to claim 1, further comprising:
receiving performance data from a website that is being optimized, an external source, or from both the website that is being optimized and the external source.

7. The method according to claim 1, further comprising:
analyzing and/or changing multiple websites.

8. The method according to claim 1, further comprising:
running on the website a process or a plurality of processes that run for a period of time then stop, continuously run, or continuously run and after some time start to dynamically change the website.

9. A method comprising:
logging all occurrences, changes, and add-to-cart clicks on a website with date/time stamps;
influencing a color range and color starting points as a factor of the date/time stamps;
monitoring the add-to-cart clicks;
querying whether there are more or less add-to-cart clicks per web page occurrence;
if an answer is that there are more add-to-cart clicks per web page occurrence, then changing a color more in a same direction;
if the answer is that there are less add-to-cart clicks per web page occurrence, then changing the color towards a previous color tone;
if the answer is that there is no change in add-to-cart clicks per web page occurrence, then not changing the color; and
displaying a web element with a selected color.

10. A method comprising:
receiving a web page request;
querying whether a background color selection should be either statistically based or randomly based;
if statistically based, selecting a background color within a range defined by a statistical analysis;
if randomly based, selecting the background color randomly from a set range of colors;
displaying the web page with a selected background color;
logging all occurrences and checkout clicks with background colors used and date/time of each of the checkout clicks;
calculating the statistical analysis of checkout performance per background color and the date/time of each of the checkout clicks; and
feeding the statistical analysis back to the step of selecting the background color within the range defined by the statistical analysis.

11. A method comprising:
receiving a web page request;
comparing an average time a user now spends on a website with the average time the user spent on the website before a last font size change;
if the average time the user now spends is longer, making a font size change more as the last font size change;
if the average time the user now spends is shorter, making the font size change opposite to the last font size change;
if the average time the user now spends is not changed, then, after every X number of times, where X is a number selected by an operator, increasing or decreasing the font size randomly within a set range to re-check if the font size change is beneficial;
displaying the web page with a selected font size change;
obtaining analytics information from an external source;
analyzing the analytics information for the average time the user spends on the website; and
feeding the average time the user spends on the website back to the comparing step.

12. A method comprising:
receiving a web page request;
selecting a background color and an image randomly for the web page within a selection range defined by a statistical analysis;
displaying the web page with a selected background color and image;
logging occurrences and contact-us clicks with the selected background color and image and a date/time for each of the contact-us clicks;
calculating the statistical analysis of the contact-us clicks per the selected background color, the image, and the date/time;
defining the selection range based on logged data for the selected background color and image; and
feeding the selection range to the selecting step.

13. A method comprising:
receiving a web page request;
selecting a background color based on a user's season, time of day, a user's geographical location, and a statistical analysis;
displaying the web page with a selected background color;
logging occurrences with the selected background color, the user's geographical location, a link to store page, and a date/time;
calculating the statistical analysis of links to store page per the selected background color, the user's geographical location, and the date/time;
defining the background color based on logged data and successive approximation; and
feeding the statistical analysis back to the selecting step.
